(19) United States
(12) Patent Application Publication
(10) Pub. No.: US 2022/0037787 A1
(43) Pub. Date: Feb. 3, 2022

(54) COMPACT ANTENNA, ANTENNA ARRAY AND TERMINAL

(71) Applicant: OnePlus Technology (Shenzhen) Co., Ltd., Shenzhen (CN)

(72) Inventors: Yongwei ZHONG, Shenzhen (CN); CHENCHUNG WU, Shenzhen (CN)

(21) Appl. No.: 17/505,295

(22) Filed: Oct. 19, 2021

Related U.S. Application Data
(63) Continuation of application No. PCT/CN2020/086089, filed on Apr. 22, 2020.

(30) Foreign Application Priority Data
Apr. 22, 2019 (CN) 201910324106.X

(51) Int. Cl. H01Q 5/378; H01Q 5/50

(52) U.S. Cl. CPC H01Q 5/378; H01Q 9/0407; H01Q 5/50

(57) ABSTRACT

A compact antenna, an antenna array and a terminal are provided. The compact antenna includes: a predetermined antenna and at least one parasitic unit corresponding to the predetermined antenna. A feed point is configured in the at least one parasitic unit. The corresponding at least one parasitic unit is fed through the feed point, such that the at least one parasitic unit has an independent antenna function.

### CROSS REFERENCE TO RELATED APPLICATION

The present application is a continuation of International Application No. PCT/CN2020/086089, filed Apr. 22, 2020, which claims priority to Chinese Patent Application No. 201910324106.X, filed Apr. 22, 2019, the entire disclosures of which are incorporated herein by reference.

### TECHNICAL FIELD

The present disclosure relates to the field of antennas, and in particular to a compact antenna, an antenna array and a terminal with the antenna.

### BACKGROUND

The fifth generation (5G) communication technology includes a millimeter wave band (24250 MHZ-52600 MHZ), and the band may be extended to a higher frequency for wireless communication. A parasitic unit may be used in antenna engineering for reducing an operating frequency of the antenna, expanding the band, achieving multiple bands, and the like. Millimeter wave antennas in the art may have two structures: a first structure may refer to a patch array having parasitic units, and a second structure may refer to the patch array having parasitic units and an independent dipole array.

In the first structure, the millimeter wave antenna has the patch array only. Space coverage of the first structure may be disadvantageous compared to the space coverage of the millimeter wave antenna of the second structure. In a terminal, the millimeter wave antenna having the first structure may have poor signal coverage in a screen or a back cover direction. In the second structure, although multiple antennas in the millimeter wave antenna array and corresponding parasitic units improve the space coverage, a physical size of the antenna may be large. Under the situation that the antenna tends to be more and more miniaturized and refined, the antenna having a large size may not be easily configured for use and may affect a size of a terminal which is configured with the antenna.

### SUMMARY OF THE DISCLOSURE

According to an implementation of the present disclosure, a compact antenna is provided. The compact antenna includes: a predetermined antenna and at least one parasitic unit corresponding to the predetermined antenna. A feed point is configured in the at least one parasitic unit, the corresponding at least one parasitic unit is fed through the feed point, such that the at least one parasitic unit has an independent antenna function.

According to another implementation of the present disclosure, an antenna array is provided an includes more than one of the antennas as described in the above, and the more than one antennas are arranged in an array.

According to still another implementation of the present disclosure, a terminal is provided and includes at least one of the above-mentioned compact antenna.

### BRIEF DESCRIPTION OF THE DRAWINGS

In order to more clearly illustrate the technical solutions of the present disclosure, the accompanying drawings for the embodiments are briefly described. It should be understood that the following drawings show only certain embodiments of the present disclosure and should not be considered as limiting the scope of the present disclosure. Other relevant drawings may be obtained by those of ordinary skill in the art without creative work.

FIG. 1 is a structural schematic view of a compact antenna according to an embodiment of the present disclosure.

FIG. 2 is a structural schematic view of a compact antenna according to an embodiment of the present disclosure.

FIG. 3 is a structural schematic view of a compact antenna according to an embodiment of the present disclosure.

FIG. 4 is a structural schematic view of a compact antenna according to an embodiment of the present disclosure.

FIG. 5 is a structural schematic view of a compact antenna according to an embodiment of the present disclosure.

FIG. 6a is a schematic view showing a direction of a compact antenna according to an embodiment of the present disclosure.

FIG. 6b is a schematic view showing a direction of a compact antenna according to an embodiment of the present disclosure.

FIG. 6c is a schematic view showing a direction of a compact antenna according to an embodiment of the present disclosure.

FIG. 7 is a comparison graph of an S parameter of a compact antenna according to an embodiment of the present disclosure.

FIG. 8 is a structural schematic view of a compact antenna according to an embodiment of the present disclosure.

FIG. 9 is a structural schematic view of a compact antenna according to an embodiment of the present disclosure.

FIG. 10 is a structural schematic view of an antenna array according to an embodiment of the present disclosure.

### DETAILED DESCRIPTION

The technical solutions of the embodiments of the present disclosure will be clearly and completely described in the following by referring to the accompanying drawings. Obviously, the embodiments described are only a part of, but not all of, the embodiments of the present disclosure. The components of the embodiments of the present disclosure described and illustrated in the accompanying drawings may be arranged and designed in various configurations. Therefore, the following detailed description of the embodiments of the present disclosure provided in the accompanying drawings is not intended to limit the scope of the present disclosure, but rather shows only selected embodiments of the present disclosure. Based on the embodiments of the present disclosure, all other embodiments obtained by those skilled in the art without creative work shall be included in the scope of the present disclosure.

Some embodiments of the present disclosure are described in detail below, by referring to the accompanying drawings. If without conflict, the following embodiments and features in the embodiments may be combined with each other.

As the wireless communication technology develops continuously, various communication systems have higher and higher requirements for broadband. In order to expand bandwidth of the antenna, at least one parasitic unit is generally configured around the antenna. The at least one parasitic unit cannot be configured independently, and is configured together with a corresponding antenna. The at least one parasitic unit is electromagnetically coupled to the corresponding antenna to achieve a parasitic function. The parasitic function reduces an operating frequency of the antenna, expands the bandwidth of the antenna, allows multiband to be formed, and the like.

The parasitic unit is configured around and close to the corresponding antenna. The parasitic unit and the corresponding antenna may be arranged in a predetermined manner. A specific position of the parasitic unit is determined based on radiation performance of the antenna. For example, the specific position may allow a maximum impedance bandwidth between the parasitic unit and the corresponding antenna to be achieved, a coupling distance corresponding to the maximum impedance bandwidth may serve as one of bases for configuring the parasitic unit. The parasitic unit may be a thin metal sheet. The thin metal sheet may be electromagnetically coupled with the corresponding antenna. An impact after electromagnetic coupling may be equivalent to a capacitor and an inductor that is connected in series or in parallel, and may serve as excitation in addition to the antenna corresponding to the parasitic unit. In this way, secondary radiation is generated. The radiation of the antenna corresponding to the parasitic unit and the secondary radiation are superimposed on one magnetic field, changing an original electromagnetic field, such that the electromagnetic field in a certain direction is strengthened, thereby increasing gain of the antenna corresponding to the parasitic unit.

Although the parasitic unit may expand the bandwidth of the corresponding antenna, the parasitic unit itself does not have the antenna function independently, i.e., the parasitic unit itself cannot work as an independent antenna. The parasitic unit can only work cooperatively with the corresponding antenna and work within an operating band of the corresponding antenna. In a scenario which has a high demand for antenna coverage, the coverage is generally improved by configuring a plurality of antennas having different main lobe directions. Although the antenna coverage is improved in this way, the number of hardware devices is increased accordingly, and a size of the antenna is increased accordingly. Therefore, designing the antenna is highly challenging while a thinner and lighter terminal is demanded.

Therefore, for the above situation, multiplexing a parasitic unit corresponding to an antenna is provided. While enabling the parasitic function of the parasitic unit relative to the corresponding antenna to be unaffected, the parasitic unit is configured to have an independent antenna function, serving as an independent antenna device that works with the corresponding antenna cooperatively. In this case, no additional hardware devices are configured, and the original antenna and the parasitic unit corresponding to the original antenna cooperatively form a structure having a plurality of antennas, forming the compact antenna as described in the present disclosure.

The compact antenna includes at least one parasitic unit corresponding to the predetermined antenna. A feed point is configured in the at least one parasitic unit. The corresponding parasitic unit is fed through the feed point to enable the parasitic unit to function as an independent antenna.

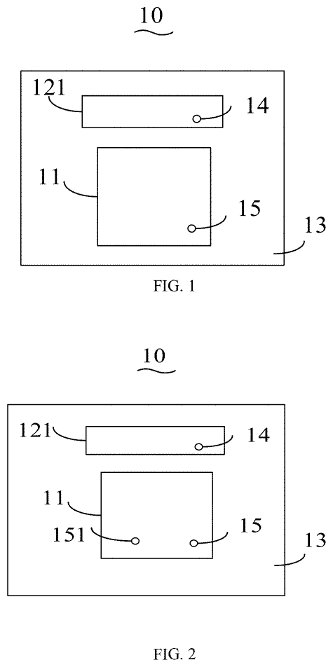

In an embodiment of the compact antenna 10, as shown in FIG. 1, the compact antenna 10 includes a predetermined antenna 11 and one first parasitic unit 121 corresponding to the predetermined antenna 11.

The first parasitic unit 121 is disposed close to the predetermined antenna 11. A specific position of the first parasitic unit 121 may be determined according to demands. The first parasitic unit 121 may be a thin metal sheet, electromagnetically coupled with the corresponding predetermined antenna 11 to expand a frequency band of the predetermined antenna 11.

The predetermined antenna 11 is configured with a first feed point 15. The predetermined antenna 11 is tuned by adjusting a position of the first feed point 15 and a mode of feeding the first feed point 15, such that an operating radio frequency of the predetermined antenna 11 is determined.

The first parasitic unit 121 is configured with a second feed point 14. The second feed point 14 is fed through a feed network, such that the first parasitic unit 121 is fed. In this way, the first parasitic unit 121 serves as a first antenna having a radio frequency function. In this case, the first parasitic unit 121 not only has the parasitic function, but also has the independent antenna function at the same time. The first parasitic unit 121 is multiplexed to work as the first antenna for sending and receiving a radio frequency signal. In other words, the predetermined antenna 11 and the first parasitic unit 121 both function as independent antennas, improving radiation performance of the compact antenna 10. In this way, the thin metal sheet serves as the first parasitic unit or an antenna radiator by adjusting the position of the feed point. When the thin metal sheet serves as the first parasitic unit, the thin metal sheet couples with the predetermined antenna to send and receive a wireless signal. When the thin metal sheet serves as the independent antenna, the thin metal sheet is independent from the predetermined antenna and serves as the independent radiator to send and receive the wireless signal.

In some embodiments, after determining an operating radio frequency band of the predetermined antenna 11, a directional map of the first parasitic unit 121 corresponding to the predetermined antenna 11 may be determined based on coverage of the compact antenna 10 and a directional map of the predetermined antenna 11.

After determining the operating radio frequency band of the first parasitic unit 121, the second feed point 14 of the first parasitic unit 121 is fed through the feed network.

In some embodiments, after feeding the second feed point 14, the first parasitic unit 121, where the second feed point 14 is located, is enabled to function as the independent antenna.

In some embodiments, a structural parameter between the predetermined antenna 11 and the first parasitic unit 121 is tuned, such that the predetermined antenna 11 and the first parasitic unit 121 corresponding to the second feed point 14 operate in a same band range, and the directional map of the predetermined antenna and the directional map of the first parasitic unit 121 are complementary, improving the coverage of the compact antenna 10. The structural parameter includes a distance between the predetermined antenna 11 and the first parasitic unit 121 corresponding to the second feed point 14, the position of the second feed point 14, the mode of feeding the second feed point 14, a shape of the first parasitic unit 121, a size of the first parasitic unit 121, and so on.

In some embodiments, the second feed point 14 is fed through the feed network. The feed network may include components, such as a matching circuit, a power divider, a phase shifter, and so on. The matching circuit may include adjustment components, such as a capacitor, an inductor, and so on.

The structural parameter, such as the position of the second feed point 14, the mode of feeding the second feed point 14, the distance between the predetermined antenna 11 and the first parasitic unit 121, the shape of the first parasitic unit 121, the size of the first parasitic unit 121, and the like, is continuously adjusted, such that a value of the component in the matching circuit, such as a value of the capacitor or a value of the inductor, is continuously changed. In this way, the matching circuit, the power divider, and phase shifter work cooperatively to change an antenna impedance of the antenna 11 and an antenna impedance of the first parasitic unit 121. Each of the antenna impedance of the antenna 11 and the antenna impedance of the first parasitic unit 121 is matched with an impedance of a feed line, and a current in the antenna is balanced, such that the directional maps of the predetermined antenna 11 and the first parasitic unit 121 are complementary, achieving optimized radiation performance.

The feeding mode may include a parallel feeding mode, a coaxial feeding mode, and the like.

In some embodiments, the predetermined antenna 11 is a patch antenna, and the antenna formed by the first parasitic unit 121 configured with the feed point is a monopole antenna.

In the present embodiment, in order to enable the compact antenna 10 to be more adapted to practical and radiation demands, the first parasitic unit 121 is rectangular. In some other embodiments, the first parasitic unit 121 may also be circular, trapezoidal, triangular, and the like, which will not be limited by the present disclosure. The shape of the first parasitic unit 121 may be determined based on arrangement of the antenna, practical needs of the antenna, and the radiation performance of the antenna.

In the present embodiment, the compact antenna 10 is a millimeter wave antenna. The millimeter wave refers to an electromagnetic wave of 24250 MHz-52600 MHz as specified in the 5G standard, and may be extended to higher frequency bands in the future as the 5G standard changes.

In some embodiments, the compact antenna 10 further includes a substrate 13. The substrate 13 provides a carrier for the compact antenna 10. That is, components, such as the predetermined antenna, all parasitic units corresponding to the predetermined antenna, feed networks, and the like, are arranged on the substrate 13.

In some embodiments, a shape of the substrate 13 may be rectangular, squared, circular, trapezoidal or triangular, which may be determined based on a scene and radiation demands. The specific shape of the substrate 13 may be determined based on the situation.

In some embodiments, a side of the substrate 13 is configured with the predetermined antenna 11 and a ground of the antenna that has the radio frequency function and is formed by the first parasitic unit 121. After the predetermined antenna 11 and the antenna, which has the radio frequency function and is formed by the first parasitic unit 121, are grounded, static electricity, lightning strikes and interference may be prevented.

As another embodiment of the compact antenna 10, as shown in FIG. 2, the compact antenna 10 includes the predetermined antenna 11 and the first parasitic unit 121 corresponding to the predetermined antenna 11.

The first parasitic unit 121 is configured with the second feed point 14. The first parasitic unit 121 is fed through the second feed point 14, such that the first parasitic unit 121 works as the first antenna having the radio frequency function. In this case, the first parasitic unit 121 not only has the parasitic function but also has the independent antenna function at the same time.

The predetermined antenna 11 is configured with two feed points, referred to as the first feed point 15 and a sixth feed point 151. The predetermined antenna 11 is fed through the two feed points to enable the predetermined antenna to be dual-polarized, reducing the number of antennas.

In the present embodiment, on the basis of the predetermined antenna 11, only the first parasitic unit 121 is multiplexed. By being fed, the first parasitic unit 121 forms the first antenna with the independent antenna function. Further, the predetermined antenna 11 and the first parasitic unit 121 are tuned by adjusting the structural parameter, such as positions of the first feed point 15 and the sixth feed point 151 in the predetermined antenna 11, a position of the second feed point 14 in the first parasitic unit 121, a mode of feeding the first feed point 15 and the sixth feed point 151, a mode of feeding the second feed point 14 in the first parasitic unit 121, the distance between the predetermined antenna 11 and the first parasitic unit 121, the size of the first parasitic unit 121, the shape of the first parasitic unit 121, and the like. In this way, the predetermined antenna 11 and the first parasitic unit 121 operate in the same band range, and the directional map of the predetermined antenna 11 and the directional map of the first parasitic unit 121 are complementary.

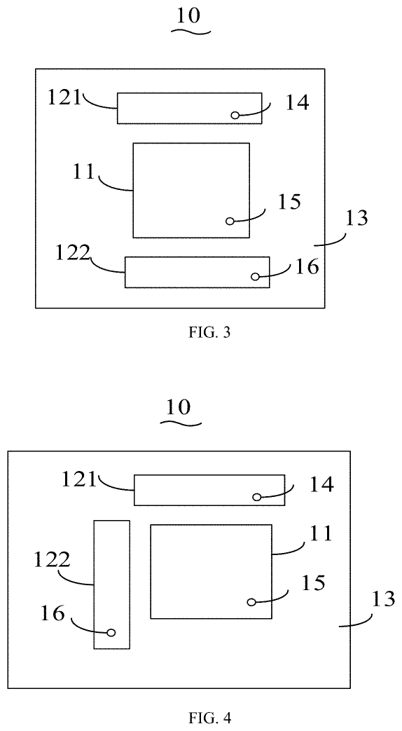

As another embodiment of the compact antenna 10, as shown in FIG. 3, the compact antenna 10 includes the predetermined antenna 11 and the first parasitic unit 121 and a second parasitic unit 122 corresponding to the predetermined antenna 11.

The first parasitic unit 121 is configured with the second feed point 14. The first parasitic unit 121 is fed through the second feed point 14, such that the first parasitic unit 121 serves as the first antenna having the radio frequency function. In this case, the first parasitic unit 121 not only has the parasitic function but also has the independent antenna function at the same time.

The second parasitic unit 122 is configured with a third feed point 16. The second parasitic unit 122 is fed through the third feed point 16, such that the second parasitic unit 122 serves as a second antenna having the radio frequency function. In this case, the second parasitic unit 122 not only has the parasitic function but also has the independent antenna function at the same time.

In the present disclosure, the first parasitic unit 121 and the second parasitic unit 122 are both multiplexed. After being fed, the first parasitic unit 121 serves as the first antenna having the radio frequency function, and the second parasitic unit 122 serves as the second antenna having the radio frequency function. The predetermined antenna 11, the first antenna, and the second antenna are tuned by adjusting the position of the first feed point 15 in the predetermined antenna 11, a mode of feeding the first feed point 15, a position of the second feed point 14, a mode of feeding the second feed point 14, a position of the third feed point 16, a mode of feeding the third feed point 16, the distance between the predetermined antenna 11 and the first parasitic unit 121, a distance between the predetermined antenna 11 and the second parasitic unit 122, a distance between the first parasitic unit 121 and the second parasitic unit 122, shapes of the first parasitic unit 121 and the second parasitic unit 122, sizes of the first parasitic unit 121 and the second parasitic unit 122. In this way, the predetermined antenna 11, the first antenna, and the second antenna operate in the same band range, and the directional map of the predetermined antenna 11, the directional map of the first antenna, and the directional map of the second antenna are complementary.

In some embodiments, in order to arrange antennas easily, a plurality of parasitic units may be provided symmetrically with respect to the predetermined antenna 11, such as the first parasitic unit 121 and the second parasitic unit 122 in FIG. 3.

In some embodiments, all feed points may be fed through a same feed network. The feed network includes the power divider, the phase shifter, and so on.

In the present embodiment, to reduce antenna hardware cost, the first feed point 15, the second feed point 14 and the third feed point 16 may be fed respectively through a same feed network. In some other embodiments, the first feed point 15, the second feed point 14 and the third feed point 16 may be fed independently from each other through three respective feed networks.

In the present embodiment, the plurality of parasitic units have an identical shape and an identical size. In some other embodiments, each of the plurality of parasitic units has a shape and a size different from each other. The shape and the size of the plurality of parasitic units are determined based on hardware design requirements and radiation performance of the compact antenna 10.

As another embodiment of the compact antenna 10, as shown in FIG. 4, the compact antenna 10 includes the predetermined antenna 11 and the first parasitic unit 121 and the second parasitic unit 122 corresponding to the predetermined antenna 11.

In order to achieve compact arrangement of the compact antenna 10, when the predetermined antenna 11 is the patch antenna, the patch antenna includes four sides. When the number of parasitic units is less than four, such as three, the three parasitic units may be disposed on any three sides of the patch antenna. Alternatively, two of the three parasitic units may be disposed symmetrically with respect to the patch antenna, and the rest one parasitic unit may be disposed on either of the other two sides of the patch antenna. Alternatively, two of the three parasitic units may be disposed symmetrically with respect to the patch antenna or disposed on any two sides of the patch antenna. When the number of parasitic units is equal to four, two of the four parasitic units may be disposed symmetrically with respect to the patch antenna, and the other two of the four parasitic units may be disposed symmetrically with respect to the patch antenna.

In the present embodiment, the first parasitic unit 121 and the second parasitic unit 122 are disposed on adjacent sides of the intended antenna 11. In this case, both the first parasitic unit 121 and the second parasitic unit 122 are multiplexed. After being fed respectively, the first parasitic unit 121 serves as the first antenna having the radio frequency function, and the second parasitic unit 122 serves as the second antenna having the radio frequency function. The predetermined antenna 11, the first antenna, and the second antenna are tuned by adjusting the position of the first feed point 15 in the predetermined antenna 11, the mode of feeding the first feed point 15, the position of the second feed point 14, the mode of feeding the second feed point 14, the position of the third feed point 16, the mode of feeding the third feed point 16, the distance between the predetermined antenna 11 and the first parasitic unit 121, the distance between the predetermined antenna 11 and the second parasitic unit 122, the distance between the first parasitic unit 121 and the second parasitic unit 122, the shapes of the first parasitic unit 121 and the second parasitic unit 122, the sizes of the first parasitic unit 121 and the second parasitic unit 122. In this way, the predetermined antenna 11, the first antenna, and the second antenna operate in the same band range, and the directional map of the predetermined antenna 11, the directional map of the first antenna, and the directional map of the second antenna are complementary.

In some embodiments, when the predetermined antenna 11 corresponds to a plurality of parasitic units, at least one of the plurality of parasitic units is configured with at least one feed point correspondingly. The at least one of the plurality of parasitic units is fed, such that the at least one of the plurality of parasitic units serves as an antenna having the independent antenna function.

The number of the at least one of the plurality of parasitic units is predetermined, and the number of the at least one antenna is predetermined.

As another embodiment of the compact antenna 10, as shown in FIG. 5, the compact antenna 10 includes the predetermined antenna 11, the first parasitic unit 121, the second parasitic unit 122, a third parasitic unit 123 and a fourth parasitic unit 124. The first parasitic unit 121, the second parasitic unit 122, the third parasitic unit 123 and the fourth parasitic unit 124 correspond to the predetermined antenna 11.

When the predetermined number is 2, i.e., 2 parasitic units are to be multiplexed, the first parasitic unit 121 is configured with the second feed point 14. The first parasitic unit 121 is fed through the second feed point 14, such that the first parasitic unit 121 serves as the first antenna having the radio frequency function. In this case, the first parasitic unit 121 not only has the parasitic function but also has the independent antenna function at the same time.

The second parasitic unit 122 is configured with the third feed point 16. The second parasitic unit 122 is fed through the third feed point 16, such that the second parasitic unit 122 serves as the second antenna having the independent antenna function. In this case, the second parasitic unit 122 not only has the parasitic function but also has the independent antenna function at the same time. The third parasitic unit 123 and the fourth parasitic unit 124 are not fed, and have the parasitic function only.

In the present embodiment, the first parasitic unit 121 and the second parasitic unit 122 are both multiplexed. After being fed respectively, the first parasitic unit 121 serves as the first antenna having the independent antenna function, and the second parasitic unit 122 serves as the second antenna having the independent antenna function. At the same time, each of the first parasitic unit 121, the second parasitic unit 122, the third parasitic unit 123 and the fourth parasitic unit 124 has the parasitic function to expand bandwidth of the compact antenna and improve the coverage of the compact antenna 10.

The predetermined antenna 11, the first antenna, and the second antenna are tuned by adjusting the structural parameter, such as the position of the first feed point 15 in the predetermined antenna 11, the mode of feeding the first feed point 15, the position of the second feed point 14, the mode of feeding the second feed point 14, the position of the third feed point 16, the mode of feeding the third feed point 16, the distance between the predetermined antenna 11 and the first parasitic unit 121, the distance between the predetermined antenna 11 and the second parasitic unit 122, the distance between the predetermined antenna 11 and the third parasitic unit 123, the distance between the predetermined antenna 11 and the fourth parasitic unit 124, the size of each parasitic unit, the shape of each parasitic unit, and distances between every two parasitic units, and the like. In this way, the predetermined antenna 11, the first antenna, and the second antenna operate in the same band range, and the directional map of the predetermined antenna 11, the directional map of the first antenna, and the directional map of the second antenna are complementary.

At the same time, each of the first parasitic unit 121, the second parasitic unit 122, the third parasitic unit 123 and the fourth parasitic unit 124 has the parasitic function to expand the bandwidth of the compact antenna and improve the coverage of the compact antenna 10.

The predetermined antenna 11 is the patch antenna, and each of the first antenna and the second antenna is the monopole antenna.

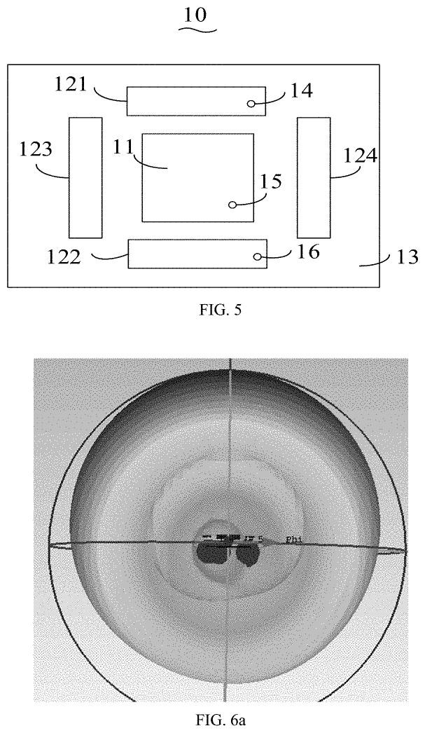

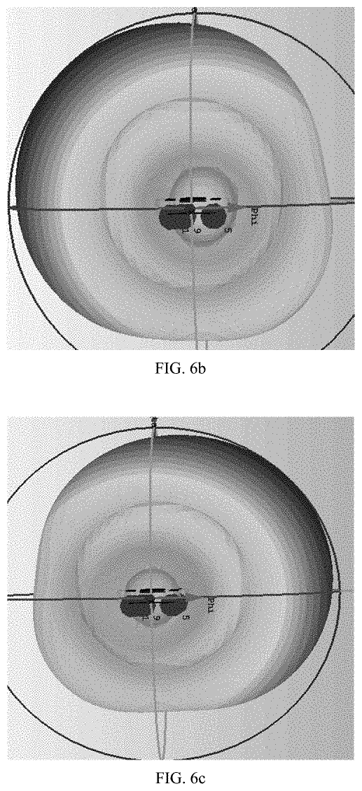

In the present disclosure, the directional map of the compact antenna 10 is illustrated by referring to FIGS. 6a-c as an example. FIG. 6a shows the directional map when the parasitic unit in FIG. 5 is not modified to be the monopole antenna. As shown in the figure, the signal is perpendicular to a direct front of the patch antenna, and two sides of the patch antenna is poorly covered. FIG. 6b shows the directional map of the first antenna, and FIG. 6c shows the directional map of the second antenna. As shown in the directional maps, signals cover sides of the antenna, and therefore, the directional maps are complementary to the directional map of the patch antenna. In this way, spatial coverage performance of the compact antenna is improved.

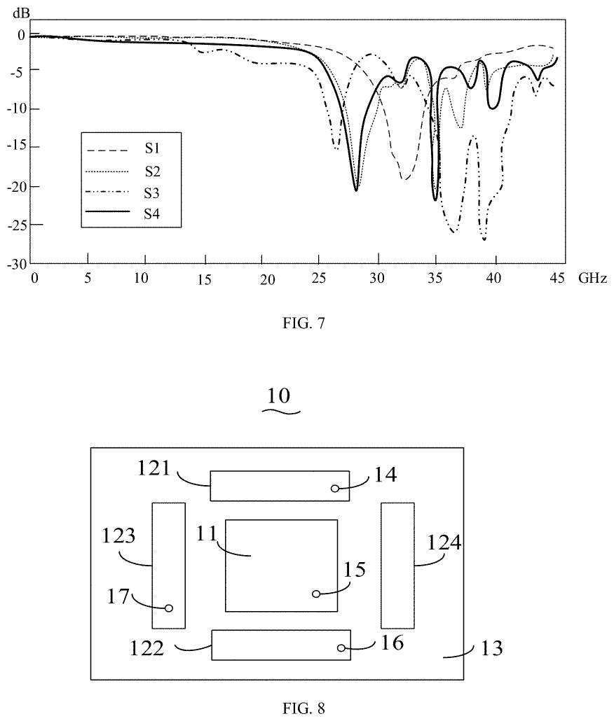

As shown in FIG. 7, FIG. 7 is a comparison graph of an S parameter of a compact antenna according to an embodiment of the present disclosure. In the figure, a curve S1^{|S(1,1)|} represents the S parameter of the patch antenna without the parasitic unit, a curve S2^{S|(1,1)|} represents the S parameter of the patch antenna with the parasitic unit, a curve S3 represents the S parameter^{S|(1,1)|} of the two monopole antennas, and a curve S4 represents the S parameter^{S|(1,1)|} of the compact antenna (the patch antenna and the multiplexed parasitic unit serving as the monopole antennas). The S parameter is a scatter parameter, which is configured to indicate various characteristics of transmission channels of signals sent by the antenna, such as signal cross-talk, signal loss, and the like. In the curve S1, the patch antenna does not have the parasitic unit, the patch antenna is a single frequency antenna, and multi-frequency is not formed. In the curve S2, as the parasitic unit is configured, multi-frequency is formed. A frequency of a first band is significantly lower than an operating frequency of the curve S1. Therefore, the parasitic unit enables the multi-frequency to be formed and enables the operating radio frequency to be reduced. In the curve S3, multi-frequency is also formed by the two monopole antennas. A frequency of the first band is significantly higher than an operating frequency of the curve S2. In the curve S4, the patch antenna and the parasitic unit serve as the monopole antennas, and the multi-frequency is formed between the patch antenna and the parasitic unit. The parasitic unit has the parasitic function as well as the radio frequency function. In this way, the multi-frequency is formed, and the operating frequency of the radio frequency is reduced. A frequency of the first band is lower than frequencies of the above three curves, and frequencies of various bands are relatively stable.

When the predetermined number is 3, i.e., 3 parasitic units are to be multiplexed, as shown in FIG. 8, after feeding the first parasitic unit 121 through the second feed point 14 to form the first antenna with the independent antenna function, and feeding the second parasitic unit 122 through the third feed point 16 to form the second antenna with the independent antenna function, the third parasitic unit 123 is configured with a fourth feed point 17. The third parasitic unit 123 is fed through the fourth feed point 17, such that the third parasitic unit 123 serves as a third antenna with the independent antenna function. The fourth parasitic unit 124 is not fed and has the parasitic function only.

In the present embodiment, the first parasitic unit 121, the second parasitic unit 122 and the third parasitic unit 123 are multiplexed. After feeding each of the first parasitic unit 121, the second parasitic unit 122 and the third parasitic unit 123, the first antenna having the radio frequency function, the second antenna having the radio frequency function, and the third antenna having the radio frequency function are formed, respectively.

The predetermined antenna 11, the first antenna, the second antenna, and the third antenna are tuned by adjusting the structural parameters, such as the position of the first feed point 15 in the predetermined antenna 11, the mode of feeding the first feed point 15, the position of the second feed point 14, the mode of feeding the second feed point 14, the position of the third feed point 16, the mode of feeding the third feed point 16, the position of the fourth feed point 17, the mode of feeding the fourth feed point 17, the distance between the predetermined antenna 11 and the first parasitic unit 121, the distance between the predetermined antenna 11 and the second parasitic unit 122, the distance between the predetermined antenna 11 and the third parasitic unit 123, the distance between the predetermined antenna 11 and the fourth parasitic unit 124, the size of each parasitic unit, the shape of each parasitic unit, and distances between every two parasitic units, and the like. In this way, the predetermined antenna 11, the first antenna, the second antenna, and the third antenna operate in the same band range, and the directional map of the predetermined antenna 11, the directional map of the first antenna, the directional map of the second antenna and the directional map of the third antenna are complementary.

Also, each of the first parasitic unit 121, the second parasitic unit 122, the third parasitic unit 123 and the fourth parasitic unit 124 has the parasitic function to expand the bandwidth of the compact antenna, improving the coverage of the compact antenna 10.

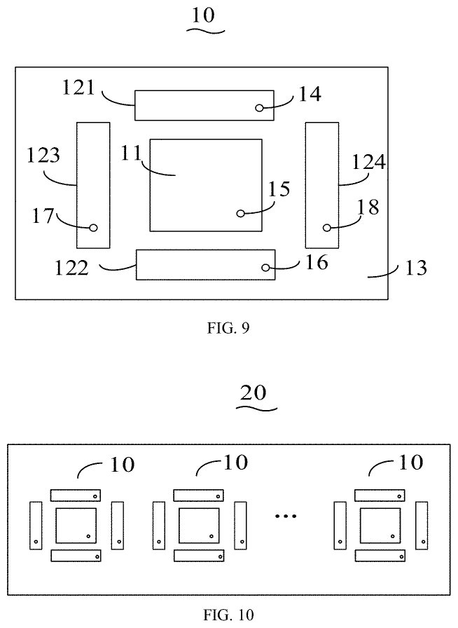

When the predetermined number is 4, as shown in FIG. 9, after feeding the first parasitic unit 121 through the second feed point 14 to form the first antenna with the independent antenna function, feeding the second parasitic unit 122 through the third feed point 16 to form the second antenna with the independent antenna function, and feeding the third parasitic unit 123 through the fourth feed point 17 to form the third antenna with the independent antenna function, the fourth parasitic unit 124 is configured with a fifth feed point 18. The fourth parasitic unit 124 is fed through the fifth feed point 18, such that the fourth parasitic unit 124 serves as a fourth antenna with the independent antenna function. The fourth parasitic unit 124 does not only have the parasitic function, but also has the independent antenna function.

In the present embodiment, the first parasitic unit 121, the second parasitic unit 122, the third parasitic unit 123 and the fourth parasitic unit 124 are multiplexed. After feeding each of the first parasitic unit 121, the second parasitic unit 122, the third parasitic unit 123 and the fourth parasitic unit 124, the first antenna having the radio frequency function, the second antenna having the radio frequency function, the third antenna having the radio frequency function, and the fourth antenna having the radio frequency function are formed, respectively.

The predetermined antenna 11, the first antenna, the second antenna, the third antenna and the fourth antenna are tuned by adjusting the structural parameters, such as the position of the first feed point 15 in the predetermined antenna 11, the mode of feeding the first feed point 15, the position of the second feed point 14, the mode of feeding the second feed point 14, the position of the third feed point 16, the mode of feeding the third feed point 16, the position of the fourth feed point 17, the mode of feeding the fourth feed point 17, the position of the fifth feed point 18 in the predetermined antenna 11, the mode of feeding the fifth feed point 18, the distance between the predetermined antenna 11 and the first parasitic unit 121, the distance between the predetermined antenna 11 and the second parasitic unit 122, the distance between the predetermined antenna 11 and the third parasitic unit 123, the distance between the predetermined antenna 11 and the fourth parasitic unit 124, the size of each parasitic unit, the shape of each parasitic unit, and distances between every two parasitic units, and the like. In this way, the predetermined antenna 11, the first antenna, the second antenna, the third antenna and the fourth antenna operate in the same band range, and the directional map of the predetermined antenna 11, the directional map of the first antenna, the directional map of the second antenna, the directional map of the third antenna and the directional map of the fourth antenna are complementary.

Also, each of the first parasitic unit 121, the second parasitic unit 122, the third parasitic unit 123 and the fourth parasitic unit 124 has the parasitic function to expand the bandwidth of the compact antenna. Therefore, the compact antenna 10 has reduced hardware cost and size and functions through multiple frequencies, the operating frequency of an individual antenna is reduced, and the coverage of the compact antenna 10 is improved.

In some embodiments, to overcome a disadvantage of a high loss of the electromagnetic wave while propagating in the millimeter wave band, an antenna array 20 as shown in FIG. 9 is provided. The antenna array 20 includes a plurality of compact antennas 10 as described above. The plurality of compact antennas 10 may have a beam scanning function to improve Effective Isotropic Radiated Power (EIRP) of the beam and spatial coverage of the beam, such that the performance requirement of the millimeter wave band of the 3GPP standard is met.

It should be noted that, the compact antenna 10 in FIG. 10 is illustrated exemplarily in one structure only. The compact antenna 10 in the antenna array 20 may be any one of the structures described in the above embodiments.

In some embodiments, the compact antenna 10 may be board-level, Low Temperature Co-fired Ceramic (LTCC), semiconductor, and other integrated processes, and may be in the form of PCB antennas, package antennas, and on-chip antennas.

In other embodiments of the present disclosure, a terminal is provided and includes the compact antenna 10 as described above or the antenna array 20 as described above. The terminal may further include components such as a memory, an input unit, a display unit, a photographic unit, an audio circuit, a wireless fidelity (WiFi) module, and a power supply. The memory may substantially include a program area and a data storage area. The program storage area may store an operating system and at least one application required for functioning. The data storage area may store data created while the terminal being used. The input unit may include a touch panel and other input devices. The display unit may include a display panel. The photographic unit is configured to capture image information within an imaging range. The audio circuit may provide an audio interface between the user and the terminal. The wireless fidelity module can facilitate the user to send and receive emails, browse web pages and access streaming media, and so on. The wireless fidelity module provides the user with wireless broadband Internet access. A main processor is a control center of the terminal. In addition to the above function, the main processor further connects various parts of the entire terminal through various interfaces and lines. The main processor may run or execute software programs and/or modules stored in the memory, and invoking data stored in the memory to perform various functions of the terminal and process data, such that the main processor performs overall monitoring of the terminal. The power supply may be logically connected to the processor through a power management system, such that functions such as charging management, discharging management, and power consumption management are achieved through the power management system. It will be understood by those skilled in the art that each of the above components does not limit the terminal, and the terminal may include more or fewer components, or a combination of certain components, or a different arrangement of the components. The terminal can be a mobile terminal or other electronic device having antenna structure.

According to the various embodiments of the present disclosure, it should be understood that, the disclosed apparatus and methods may also be implemented by other means. The embodiments of the devices described above are merely exemplary. For example, the flow charts and schematic diagrams in the accompanying drawings show possible implementations of the architecture, functionality, and operation of the devices, methods, and computer program products according to the various embodiments of the present disclosure. In this regard, each block in the flow chart and in the schematic diagram may represent a module, a program segment, or a portion of codes, the module, the program segment, or the portion of codes contains one or more executable instructions for implementing prescribed logical functions. Also, it should be noted that in an alternative implementation, the function indicated in the block may also be achieved in an order different from that indicated in the accompanying drawings. For example, two consecutive blocks can be executed in substantially parallel, or in an opposite order sometimes. The order is determined based on involved functions. It should also be noted that, each block in the schematic diagram and/or the flow chart, and combination of blocks in the schematic diagram and/or the flow chart may be implemented with a dedicated hardware-based system that performs the specified function or action, or may be implemented with a combination of dedicated hardware and computer instructions.

In addition, various functional modules or units in various embodiments of the present disclosure may be integrated together to form an independent portion. Alternatively, the individual modules may function alone. Alternatively, two or more modules may be integrated to form an independent portion.

The above description shows only a specific implementation of the present disclosure, but the scope of the present disclosure is not limited thereto. Any changes or substitutions that can be readily thought of by any person skilled in the art within the scope of the technology disclosed in the present disclosure shall be covered by the scope of the present disclosure.

What is claimed is:

1. A compact antenna, comprising:
a predetermined antenna; and
at least one parasitic unit corresponding to the predetermined antenna;
wherein a feed point is configured in the at least one parasitic unit, the corresponding at least one parasitic unit is fed through the feed point, such that the at least one parasitic unit has an independent antenna function.

2. The compact antenna according to claim 1, wherein an operating radio frequency of the at least one parasitic unit corresponding to the feed point is tuned by adjusting a position of the feed point and a mode of feeding the feed point, such that the at least one parasitic unit is in a predetermined operating band.

3. The compact antenna according to claim 2, wherein:
a structural parameter between the predetermined antenna and the at least one parasitic unit corresponding to the feed point is tuned, such that a directional map of the predetermined antenna is complementary to a directional map of the at least one parasitic unit corresponding to the feed point; and
the structural parameter comprises a distance between the predetermined antenna and the at least one parasitic unit corresponding to the feed point, the position of the feed point and the mode of feeding the feed point.

4. The compact antenna according to claim 1, wherein the number of the at least one parasitic unit is one, the predetermined antenna corresponds to one parasitic unit, and one feed point is provided in the one parasitic unit.

5. The compact antenna according to claim 1, wherein the number of the at least one parasitic unit is more than one, the predetermined antenna corresponds to more than one parasitic units, at least one of the more than one parasitic units is selected to be configured with the feed point.

6. The compact antenna according to claim 5, wherein the more than one parasitic units are distributed on different sides of the predetermined antenna.

7. The compact antenna according to claim 6, wherein the more than one parasitic units are distributed symmetrically with relative to the predetermined antenna.

8. The compact antenna according to claim 5, wherein the feed point of all of the at least one parasitic unit is fed through a feed network.

9. The compact antenna according to claim 1, wherein two feed points are configured in the predetermined antenna, and the predetermined antenna is fed through the two feed points.

10. The compact antenna according to claim 1, wherein the predetermined antenna is a patch antenna, and the at least one parasitic unit configured with the feed point serves as a monopole antenna.

11. An antenna array, comprising more than one compact antennas arranged in an array, wherein each of the more than one compact antennas comprises:
a predetermined antenna; and
at least one parasitic unit corresponding to the predetermined antenna;
wherein a feed point is configured in the at least one parasitic unit, the corresponding at least one parasitic unit is fed through the feed point, such that the at least one parasitic unit has an independent antenna function.

12. The antenna array according to claim 11, wherein an operating radio frequency of the at least one parasitic unit corresponding to the feed point is tuned by adjusting a position of the feed point and a mode of feeding the feed point, such that the at least one parasitic unit is in a predetermined operating band.

13. The antenna array according to claim 12, wherein:
a structural parameter between the predetermined antenna and the at least one parasitic unit corresponding to the feed point is tuned, such that a directional map of the predetermined antenna is complementary to a directional map of the at least one parasitic unit corresponding to the feed point; and
the structural parameter comprises a distance between the predetermined antenna and the at least one parasitic unit corresponding to the feed point, the position of the feed point and the mode of feeding the feed point.

14. The antenna array according to claim 11, wherein the number of the at least one parasitic unit is one, the predetermined antenna corresponds to one parasitic unit, and one feed point is provided in the one parasitic unit.

15. The antenna array according to claim 11, wherein the number of the at least one parasitic unit is more than one, the predetermined antenna corresponds to more than one parasitic units, at least one of the more than one parasitic units is selected to be configured with the feed point.

16. The antenna array according to claim 15, wherein the more than one parasitic units are distributed on different sides of the predetermined antenna.

17. The antenna array according to claim 15, wherein the feed point of all of the at least one parasitic unit is fed through a feed network.

18. The antenna array according to claim 11, wherein two feed points are configured in the predetermined antenna, and the predetermined antenna is fed through the two feed points.

19. The antenna array according to claim 11, wherein the predetermined antenna is a patch antenna, and the at least one parasitic unit configured with the feed point serves as a monopole antenna.

20. A terminal, comprising a compact antenna, wherein the compact antenna comprises:
a predetermined antenna; and
at least one parasitic unit corresponding to the predetermined antenna;
wherein a feed point is configured in the at least one parasitic unit, the corresponding at least one parasitic unit is fed through the feed point, such that the at least one parasitic unit has an independent antenna function.
